(19) United States
(12) Patent Application Publication
(10) Pub. No.: US 2014/0032445 A1
(43) Pub. Date: Jan. 30, 2014

(54) METHODS, SYSTEMS, AND COMPUTER READABLE MEDIA FOR DETERMINING AND PRESENTING OPTIMUM SOCIAL SECURITY RETIREMENT BENEFITS FILING STRATEGIES

(71) Applicant: Impact Technologies Group, Inc., Charlotte, NC (US)

(72) Inventors: Gretchen K. Smith, Davidson, NC (US); J. Maxey Sanderson, Faith, NC (US)

(21) Appl. No.: 13/941,344

(22) Filed: Jul. 12, 2013

Related U.S. Application Data
(60) Provisional application No. 61/676,270, filed on Jul. 26, 2012.

(51) Int. Cl. G06Q 40/06

(52) U.S. Cl. CPC G06Q 40/06
USPC 705/36 R

(57) ABSTRACT

A method for determining and presenting optimum social security benefits strategies received includes receiving input regarding at least one social security retirement benefits participant's age and full retirement age benefit amount. The method includes calculating, for each of a plurality of filing strategies and based on the inputs and the life expectancy of the at least one social security retirement benefits participant, a monetary value of social security benefits for a plurality of different benefits start ages of the participant and outputting indication of the relative monetary benefits for the different benefits start ages.

### RELATED APPLICATIONS

The presently disclosed subject matter claims the benefit of U.S. Provisional Patent Application Ser. No. 61/676,270, filed Jul. 26, 2012; the disclosure of which is incorporated herein by reference in its entirety.

### TECHNICAL FIELD

The subject matter described herein relates to social security retirement benefits. More particularly, the subject matter described herein relates to methods, systems, and computer readable media for determining and presenting optimum social security retirement benefits strategies.

### BACKGROUND

### Social Security Benefit Decision Matrix

When a participant files for Social Security retirement benefits, many decisions must be made. If the participant is married, the options are many and a complete analysis of best timing and method of filing requires numerous calculations.

There a period of 9 years, ages 62 through 70, when starting Social Security is possible, or 81 combinations of ages for a married couple.

### Strategies

In addition to selecting an age, the participants may also collect benefits in more than one way. These options are:
File for benefits on your own Social Security employment record
File for benefits based on your spouse's Social Security employment record (spousal benefit)
Collect the larger of your own benefit or your spousal benefit
“File and Suspend” your benefits to a later age, allowing spouse to collect spousal benefits while you increase your benefits by delay credits
File a “Restricted Application” for spousal benefits only while delaying your own benefits until a later date and thereby increasing your own benefit when you switch to it at a later date
A combination: One spouse “Files and Suspends” while the other files a “Restricted Application”
   These strategies produce 7 possible ways a couple could receive benefits. Combined with the 81 possible age combinations, there are up to 567 potential sets of calculations to compare. The strategies include:
1. No special filing, each person files for their benefits at the indicated ages.
2. Spouse A Files and Suspends benefits to a later date
3. Spouse B Files and Suspends benefits to a late date
4. Spouse A files a Restricted Application
5. Spouse B files a Restricted Application
6. Spouse A Files and Suspends, Spouse B files a Restricted Application
7. Spouse B Files and Suspends, Spouse A files a Restricted Application

Current methods for determining optimum social security benefits strategies typically involve “rule of thumb” strategies without completely analyzing all of the available options. Such rule of thumb calculations may lead to participants receiving less benefit than alternate strategies.

Accordingly, there exists a need for methods, systems, and computer readable media for determining and presenting optimum social security retirement benefits filing strategies.

### SUMMARY

A method for determining and presenting optimum social security benefits strategies received includes receiving input regarding at least one social security retirement benefits participant's age and full retirement age benefit amount. The method includes calculating, for each of a plurality of filing strategies and based on the inputs and the life expectancy of the at least one social security retirement benefits participant, a monetary value of social security benefits for a plurality of different benefits start ages of the participant and outputting indication of the relative monetary benefits for the different benefits start ages.

The subject matter described herein for determining and presenting optimum social security retirement benefits filing strategies may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be described in reference to the accompanying drawings of which:

FIG. 1 is a block diagram illustrating an exemplary system for determining and presenting optimum social security retirement benefits strategy according to an embodiment of the subject matter described herein;

FIG. 2 is a flow chart illustrating exemplary overall steps for determining optimum social security benefits filing strategies according to an embodiment of the subject matter described herein;

FIG. 3 is a computer screen shot illustrating presentation value of social security benefits for different combinations of benefits start ages according to an embodiment of the subject matter described herein;

FIG. 4 is a computer screen shot illustrating another example of presentation of relative monetary value of different combinations of social security benefit start ages according to an embodiment of the subject matter described herein;

FIG. 5 is a computer screen shot illustrating presentation of relative monetary value of social security benefits start ages for a single participant according to an embodiment of the subject matter described herein;

FIG. 6 is a flow chart illustrating exemplary steps for determining a best age combination for two married persons according to an embodiment of the subject matter described herein;

FIGS. 7A and 7B are flow charts illustrating exemplary steps for determining a best filing option by age according to an embodiment of the subject matter described herein;

FIG. 8 is a flow chart illustrating exemplary steps for determining a best age starting social security benefits for a single person according to an embodiment of the subject matter described herein;

FIG. 9 is a flow chart illustrating exemplary steps for determining annual calculation values of single or married participant according to an embodiment of the subject matter described herein;

FIG. 10 is a flow chart illustrating exemplary steps for calculating a social security benefit amount according to an embodiment of the subject matter described herein; and

FIGS. 11A and 11B are flow charts illustrating exemplary steps for calculating annual social security benefits according to an embodiment of the subject matter described herein.

### DETAILED DESCRIPTION

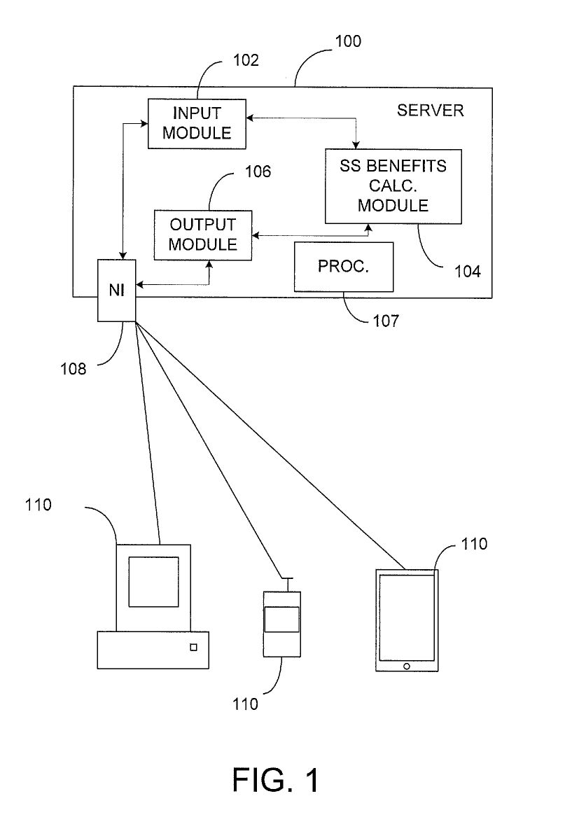

FIG. 1 is a block diagram illustrating an exemplary system for determining optimum social security benefits filing strategies according to an embodiment of the subject matter described herein. Referring to FIG. 1, a computing platform, such as a server 100, includes an input module 102, a social security benefits calculator 104, an output module 106 and a processor 107. Input module 102 may receive input regarding at least one social security benefits participant's age and full retirement age benefit amount. Social security benefits calculator 104 calculates, for each of a plurality of different filing strategies and based on the inputs and the life expectancy of at least one participant, a monetary value of social security benefits for a plurality of different social security benefits start ages. Output module 106 may output an indication of the relative monetary benefits for the different benefits start ages. Processor 107 may execute the various modules of server 100.

Server 100 may also include a network interface 108 through which components 102, 104, and 106 can communicate with user devices 110. In the illustrated example, user devices 110 include desktop computers, mobile phones, and/or tablet computers. However, the subject matter described herein is capable of interfacing with any type of user devices. Moreover, the subject matter described herein is not limited to the server-based architecture illustrated in FIG. 1. In an alternate implementation, components 102, 104, and 106 may be located on any of client devices 110 without departing from the scope of the subject matter described herein.

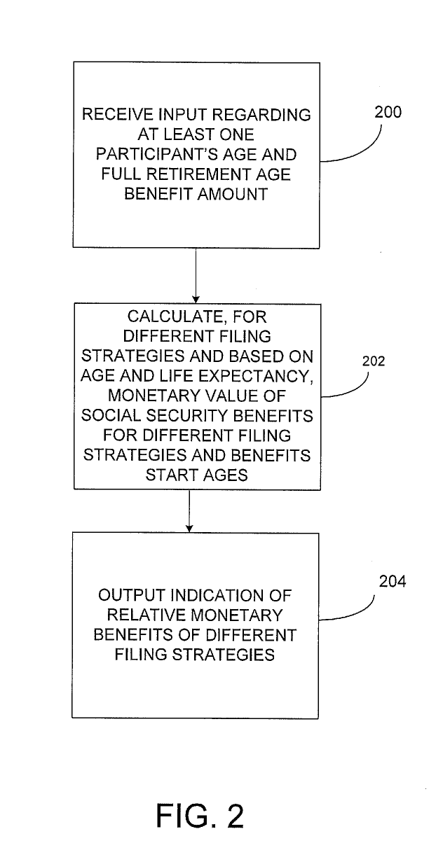

FIG. 2 is a flow chart illustrating exemplary overall steps for determining optimum social security benefits filing strategies according to an embodiment of the subject matter described herein. Referring to FIG. 2, in step 200, input is received regarding participant's age and full retirement age benefit amount. In step 202, a monetary value of social security benefits for different filing strategies is calculated based on the inputs and life expectancies of at least one participant. In step 204, an indication of the relative monetary benefits of different filing strategies is output. The examples below illustrate exemplary calculations and outputs that may be presented by the system illustrated in FIG. 1.

### Graphical Display—Best Age Combination for 2 Spouses

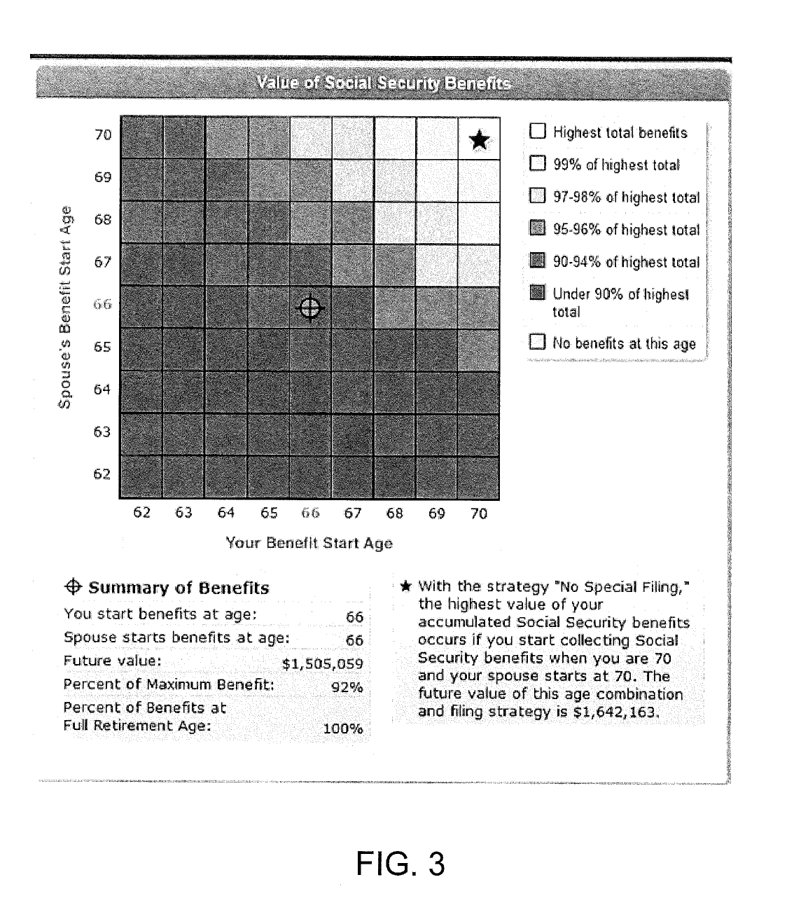

Referring to FIG. 3, output module 106 illustrated in FIG. 1 may display a 9×9 grid that shows values representing the possible age combinations for a single strategy chosen from the above list. The X-axis represents ages 62-70 of the first spouse and the Y-axis represents ages 62-70 for the other spouse. The colors of the squares in the graph display the relative value of the total benefits receive over time: the lighter the color, the higher the total. The “best” option is displayed with a star. The user can use the mouse, touch the screen, or use another selection device to display further details of the underlying calculations. This display requires up to 81 sets of calculations over the designated years the spouses are assumed to live. The calculation methods are described in below.

### Graphical Display—Best Strategy by Age for 2 Spouses

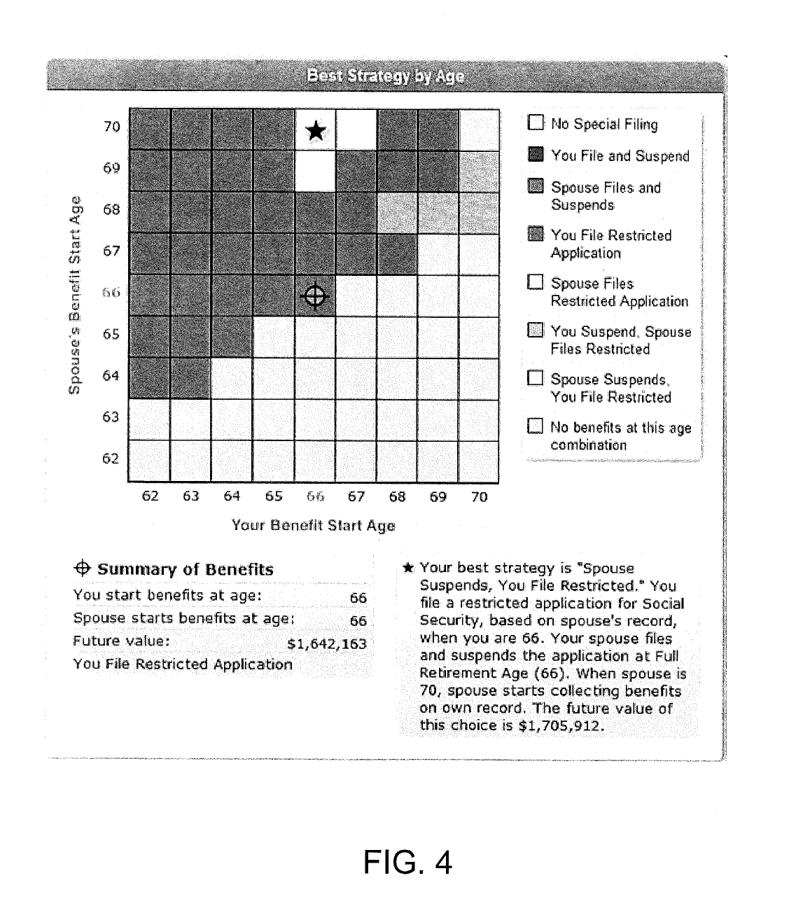

Referring to FIG. 4, output module 106 illustrated in FIG. 1 may display a 9×9 grid that shows values representing the best possible strategy for a given age. The X-axis represents ages 62-70 of the first spouse and the Y-axis represents ages 62-70 for the other spouse. The colors of the squares in the graph show which strategy of the seven produces the highest total benefit for a given age combination. The age combination with the highest total benefit is displayed with a star. The user can use the mouse, touch the screen, or use another selection device to display further details of the underlying calculations. This display requires up to 567 sets of calculations over the designated years the spouses are assumed to live. The calculation methods are described below.

### Graphical Display—Best Age for a Non-Married Person

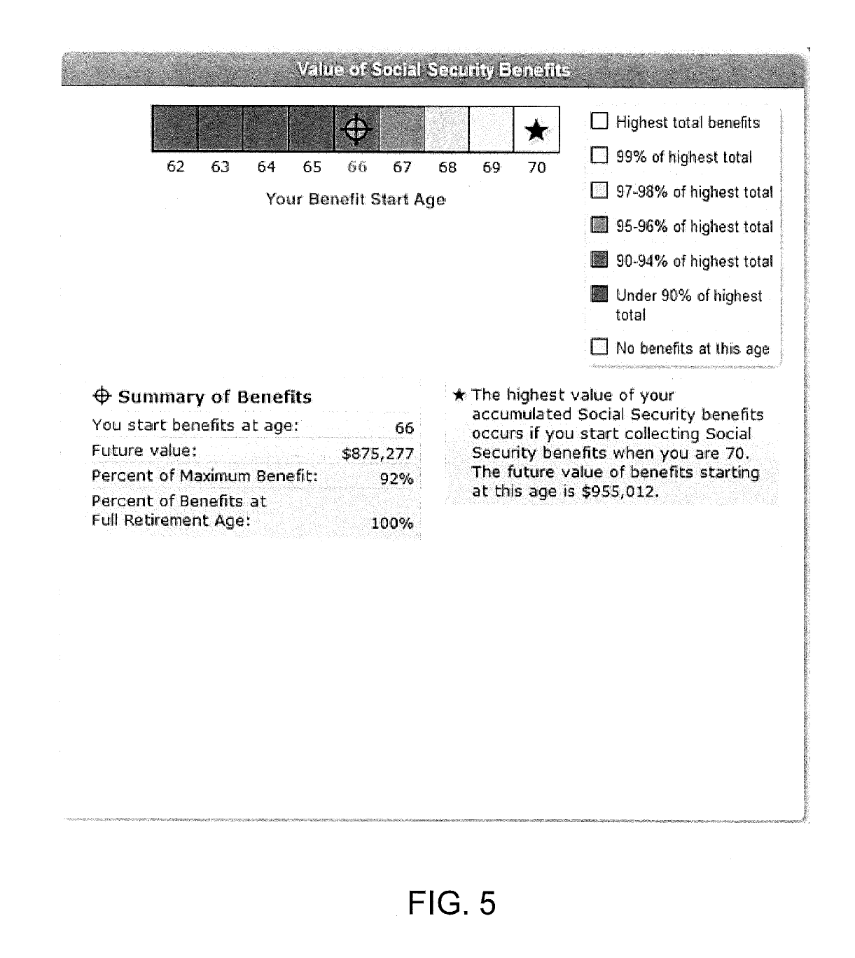

Referring to FIG. 5, output module 106 illustrated in FIG. 1 may display a 9×1 grid that shows values representing the ages for a single person may file for Social Security benefits. The X-axis represents ages 62-70. The colors of the squares in the graph display the relative value of the total benefits receive over time: the lighter the color, the higher the total. The “best” option is displayed with a star. The user can use the mouse, touch the screen, or use another selection device to display further details of the underlying calculations. This display requires up to 9 sets of calculations over the designated years the person is assumed to live. The calculation methods are described below.

### Methodology

The graph requires input from the user, for each person analyzed:
Current age
Benefit amount at Full Retirement Age (FRA) from a Social Security

### Benefit Statement

Estimated mortality age
   Additional assumptions include, as input by the user:
Assumed inflation rate for Social Security cost of living annual adjustments
Assumed investment rate for evaluating the time value of money over the years illustrated
   For Best age combination for 2 spouses, an additional input specifies which of the 7 strategies to analyze.

### Calculations

Social Security Benefits are based on user input of the estimated benefit amount at full retirement age, as found on a Social Security Benefit statement. Alternatively, benefit amounts could be estimated using current earnings as a percentage of Annual Indexed Monthly Earnings (AIME) to produce an estimated Primary Insurance Amount (PIA) using formulas utilized by the Social Security Administration. If the starting age for benefits is not equal to Full Retirement Age (FRA), the benefit amount is adjusted by formula for the years prior or after FRA.

Cost of Living (COLA) increases use the input Inflation Rate, applied annually to each year's benefit amounts. The first increase is considered to occur at the start of year 2 and continue through the years to calculate.

Years to calculate is equal to the greater of {Life expectancy for person 1 minus age person 1 or Life expectancy for person 2 minus age person 2} for 2 married persons; Life expectancy minus age for a single person.

During the calculations, the future value of the benefit income stream is calculated using the input Investment Rate. The balance is initialized to 0 and each year annual compound interest is applied to the balance. Next, the total Social Security benefits are added to the balance to determine the future value at the end of a calculation year.

The future value of the benefits as invested in the last year illustrated is used to compare one set of calculations to another. The highest future value is considered the “best” age or strategy.

### Best Age Combination for 2 Spouses

Depending on the current age of the two persons, 81 sets of calculations are done, each with a distinct set of Social Security start ages: e.g. Person A starts at 62, Person B starts at 62; Person A starts at 62, Person B starts at 63; etc. One of the Strategies above is applied to the calculation sets. The 81 sets will cover start ages 62 through 70 for each person and the results are stored in an array. After completing the 81 calculations, the result sets are examined to find the set with the highest future value at the end of the years calculated. The maximum value and the associated ages are noted.

Two additional calculations are performed on each set: the percent of the future value in a set to the highest future value (percent of maximum benefit), and the percent of the future value of the future value for both persons starting Social Security benefits at Full Retirement Age (percent of Full Retirement benefit).

The results are used to fill in the 9×9 grid by starting ages. The color of each square in the grid represents the percent of maximum benefit. The lightest color is assigned to the square with the maximum benefit. Other colors from light to darker represent 99% of the maximum, 97-98%, 95-96%, 90-94%, and less than 90%. The square with the highest future value (maximum benefit) is denoted with a star graphic.

Additional information from the results can be obtained by clicking or touching a square. The summary box shows the starting ages for both persons, the future value of benefits, percent of maximum benefit and percent of Full Retirement Age benefits. Clicking or touching a square also serves as an input selection for benefit start ages for other calculators in the tool.

### Best Strategy by Age for 2 Spouses

Best Strategy by Age performs 7 sets of calculations as described in Best Age Combination for 2 Spouses, one each for the 7 strategies above. The results are stored in an array. After completing the 7 sets of calculations (567 result sets), the results are examined by age combination to determine which strategy produces the highest future value for a given start age. The future value, corresponding ages and strategy are stored for use in the graphic. In addition, the highest overall future value is saved.

The graph colors are determined by the best strategy for a given age combination. Each of the 7 strategies has a unique color. The square with the highest future value (maximum benefit) is denoted with a star graphic.

Additional information from the results can be obtained by clicking or touching a square. The summary box shows the starting ages for both persons, the future value of benefits, and strategy used. Clicking or touching a square also serves as an input selection for benefit start ages for other calculators in the tool.

### Best Age for a Non-Married Person

Best Age for a non-married person uses up to 9 calculation sets, one for each age from 62 through 70. No strategy is applied to non-married calculations. The results are stored in an array. The results are used to fill in a 9×1 grid by starting age.

The color of each square in the grid represents the percent of maximum benefit. The lightest color is assigned to the square with the maximum benefit. Other colors from light to darker represent 99% of the maximum, 97-98%, 95-96%, 90-94%, and less than 90%. The square with the highest future value (maximum benefit) is denoted with a star graphic.

Additional information from the results can be obtained by clicking or touching a square. The summary box shows the starting age, the future value of benefits, percent of maximum benefit and percent of Full Retirement Age benefits is displayed. Clicking or touching a square also serves as an input selection for benefit start age for other calculators in the tool.

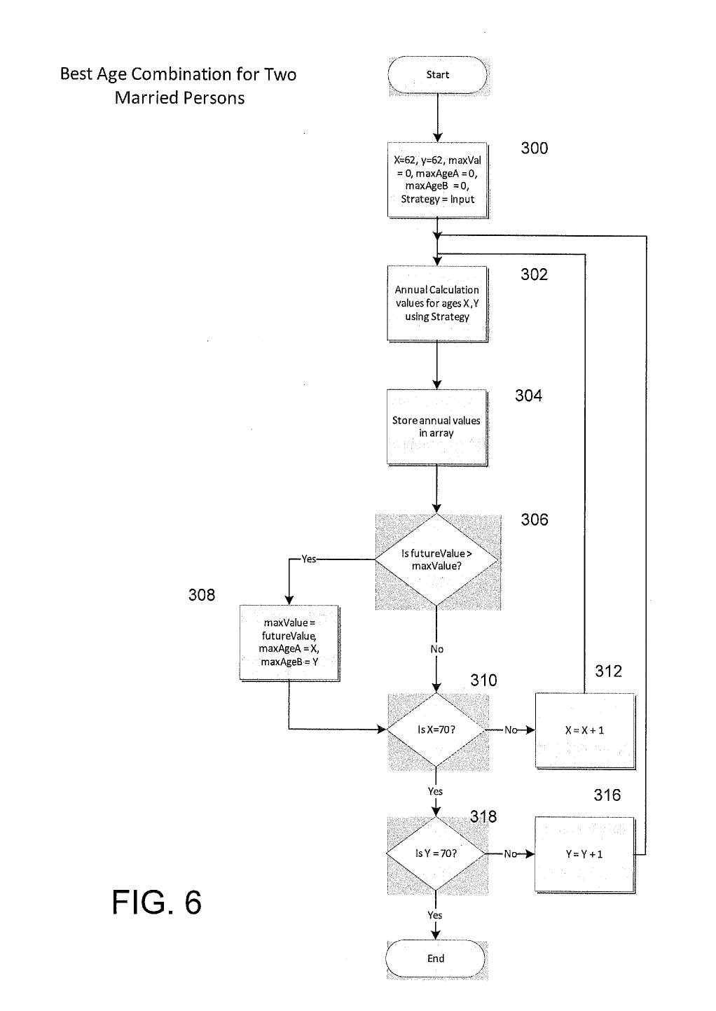

FIGS. 6-11B are flow charts illustrating exemplary calculations that may be performed by social security benefits calculator 104 illustrated in FIG. 1.

FIG. 6 is a flow chart illustrating a process for determining a best age combination for the purpose of maximizing social security benefits for two married persons according to an embodiment of the subject matter described herein. The best age combination refers to the combination of ages that maximizes total social security benefit payments to the two married persons.

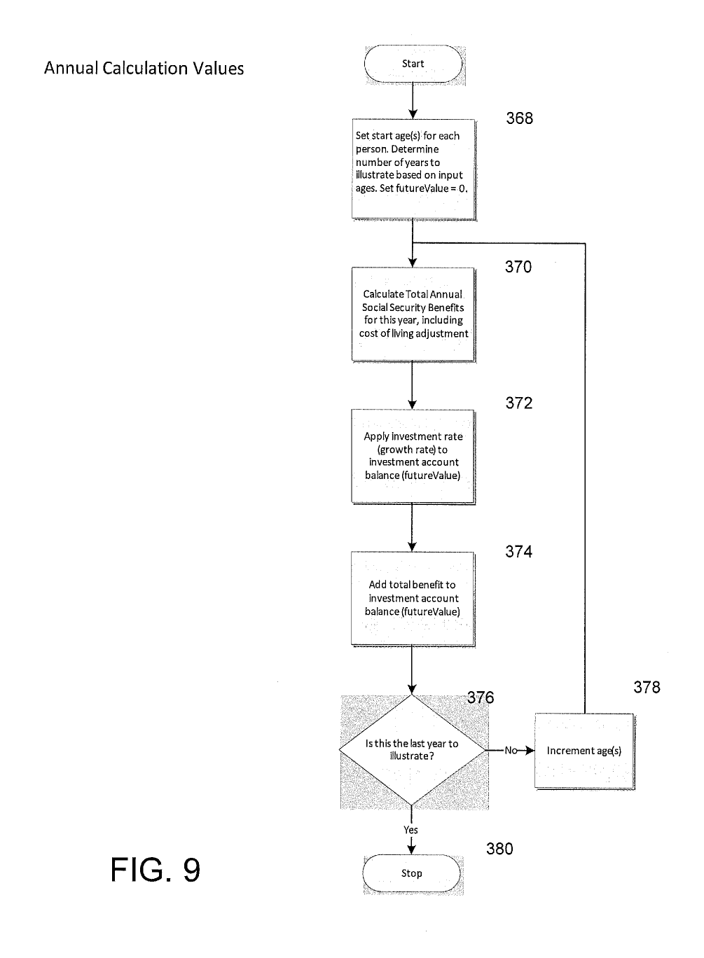

Referring to FIG. 6, step 300 illustrates the initialization of values needed for iterating over ages of 62 through 70 for each of two persons (person 1 and person 2). Variables maxAgeA and maxAgeB will hold the start age which provides the highest cumulative benefits over the years from starting Social Security benefits until death ages input. In step 302, an array of annual values is calculated, which will be explained in detail below with respect to FIG. 9. In step 304, calculation results from step 302 are stored in an array of annual values arrays. In step 306, the futureValue (cumulative total benefits received) in the last year of the annual values calculated in step 302 is compared to maxValue, which stores the current maximum cumulative total social security benefits for a given combination of ages and filing options. In step 308, if the futureValue in the last year of the annual values calculated in step 302 is greater than the maxValue, replace maxValue with futureValue and replace maxAgeA with X and maxAgeB with Y. In step 310, the variable X which stores the age variable for one spouse is compared to 70, the latest age the person is assumed to start receiving benefits. If the regulations change, the comparison in step 310 can be changed so that the value of X is compared to the maximum benefit initiation age. The other comparisons to 70 described herein and process steps that depend on the maximum benefits age can also be modified accordingly. Similarly, 62 is the current minimum start age for benefits. If the regulations change, the steps and comparisons described herein that relate to the minimum benefits start age can be modified to reflect the new benefits start age.

In step 310, if X is less than 70, X is incremented by 1 and control returns to step 302 where the annual calculation values are computed for the new age variable. If X=70, control proceeds to step 314, where the variable Y, which stores the age for the other spouse, is compared to 70. In step 316, if Y is less than 70, Y is incremented, and control returns to step 302 where iteration is repeated for the next age value for the second spouse. If Y=70, the calculation is complete, and the array of annual values arrays is returned as a result. The array of annual values arrays stores annual totals of social security compensation that will be paid to each spouse.

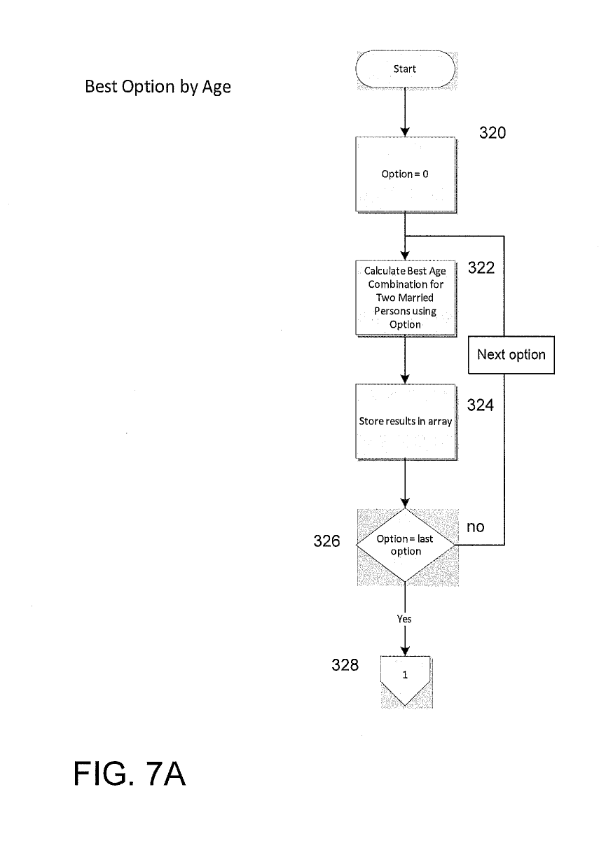

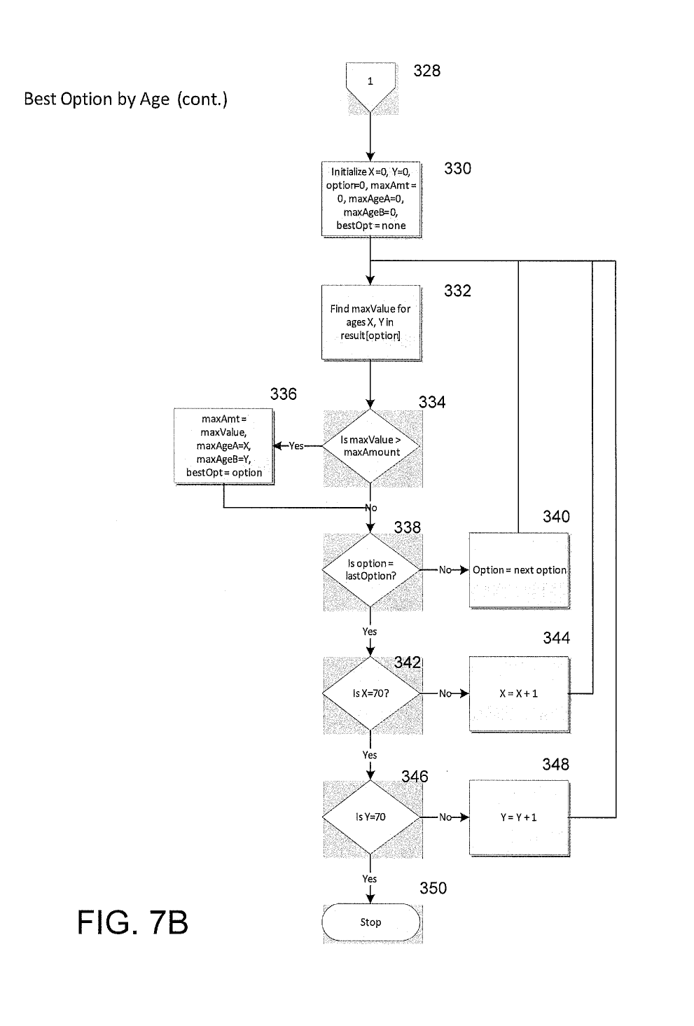

FIGS. 7A and 7B are flow charts illustrating exemplary steps for determining a best filing option by age for two married persons according to an embodiment of the subject matter described herein. Referring to FIG. 7A, in step 320, a variable called Option (Strategy) is initialized to 0, which corresponds to a first social security benefits filing option. There are six possible Strategies in this order: No Special Filing; You File and Suspend; Spouse Files and Suspends; You File Restricted Application; Spouse Files Restricted Application; You File and Suspend, Spouses Files Restricted Application; and Spouse Files and Suspends, You File Restricted Application. Thus, in this example setting Option to 0 means option corresponds to No Special Filing.

In step 322, a best age combination for two married persons is calculated using the steps illustrated in FIG. 6. In step 324, the results from step 322 are stored in an array of results array. In step 326, it is determined whether the current option is the last option in the list. If the current option is not the last option, the variable option is set to the next option in the list and control returns to step 322 where the iteration is repeated for the next option. For example, “You file and suspend” may be the next option for which the best age combination is calculated. If the current option is the last option in the list, then control proceeds to FIG. 7B.

Referring to FIG. 7B, in step 328, the process of determining the best filing option continues. In step 330, the variables X, Y, maxAgeA, maxAgeB, maxAmount (maxAmt), option (Strategy) and bestOpt to start iteration over the array of result arrays produced in step 324. In step 332, the maxValue in the array entry for a given option is located. The variable maxValue represents the highest total benefit value in the array for a given age combination. In step 334, the value of the variable maxValue is compared to the value of the variable maxAmount, which stores the current highest total benefit value for an age and option combination determined so far as the program iterates through the options. In step 336, if maxValue is greater than maxAmt, the value of the variable maxAmt is replaced with the value of the variable maxValue, the value of the variable maxAgeA is set to X, the value of the variable maxAgeB is set to Y, and the value of the variable bestOpt is set to the current option. In step 338, it is determined whether the current option being tested is that last option in the list. If the current option is not the last option, control proceed to step 340 where the variable option is set to the next option in the list and control proceeds to step 332 where the iteration is repeated. If the current option is the last option, control proceeds to step 342 where it is determined whether X=70. If X is not equal to 70, X is incremented by one, and control proceeds to step 332 where the iteration is repeated. If X=70, control proceeds to step 346, where it is determined whether Y=70. If y is not equal to 70, Y is incremented by one, and control proceeds to step 332 where the iteration is repeated. If Y=70, control proceeds to step 350 where the process ends and results, including bestOpt, maxAgeA and maxAgeB, are returned. Thus, at the end of the process in FIG. 7B, the option and age combination that maximizes social security benefits for two married people is output.

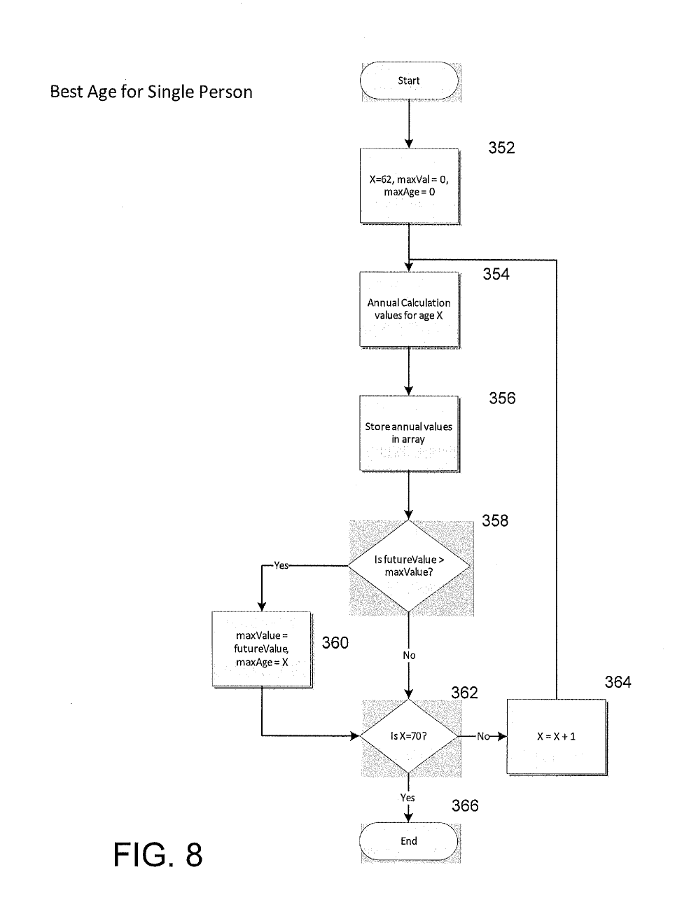

FIG. 8 is a flow chart illustrating exemplary steps for determining a best age starting social security benefits for a single person according to an embodiment of the subject matter described herein. Referring to FIG. 8, in step 352, the age variable X is initialized to 62 and the MaxVal and MaxAge variables are each initialized to zero. The variable maxAgeA will hold the start age which provides the highest cumulative benefits over the years from starting Social Security benefits until death ages input. In step 354, an array of annual values is calculated using the process described below with respect to FIG. 9. In step 356, calculation results from step 354 are stored in an array of annual values array. In step 358, the value of the variable futureValue in the last year of the annual values calculated and in step 345 is compared to maxValue. If the futureValue in the last year of the annual values calculated in step 354 is greater than the maxValue, control proceeds to step 360 where the value of the variable maxValue is replaced with the value for the variable futureValue and maxAgeA is replaced with the current value of the variable X. If the value for the variable futureValue is not greater than MaxValue or after step 360, control proceeds to step 362 where it is determined whether X=70. If X is not equal to 70, control proceeds to step 364 where the value of X is incremented by 1 and control returns to step 354 for the next iteration. If the X=70, control proceeds to step 366 where the process ends.

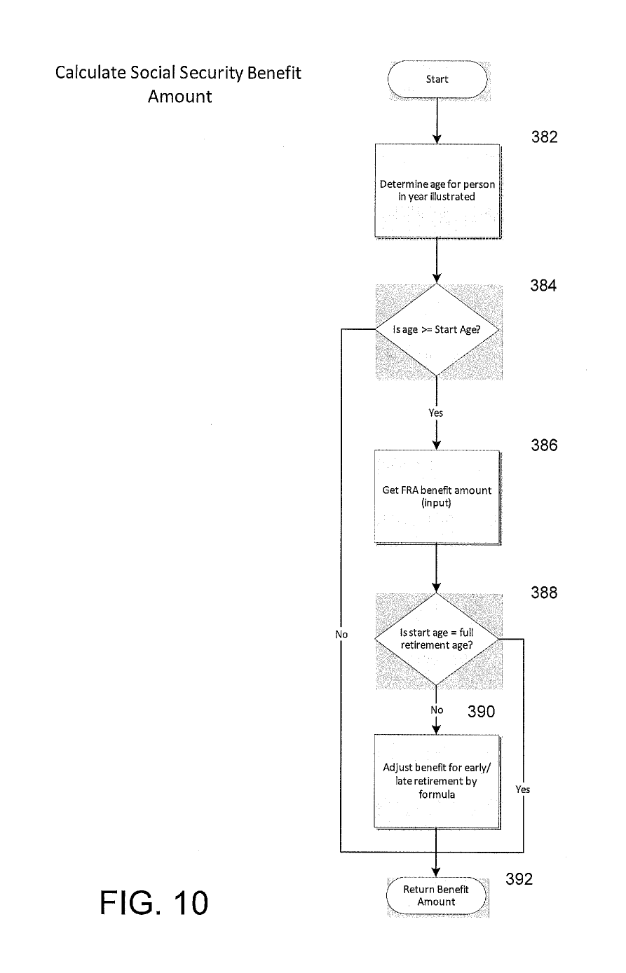

FIG. 9 is a flow chart illustrating exemplary steps for determining annual calculation values of single or married participant according to an embodiment of the subject matter described herein. Referring to FIG. 9, in step 368, values needed for an iteration are initialized. In particular, social security start ages are set as input and years are set to be equal to the greater of death for A minus age A or death age for B minus age B. The value of the variable futureValue is set to 0. In step 370, total Annual Social Security Benefits are calculated for this year including Cost of Living Adjustment as described with respect to FIG. 10. If there are 2 persons, the total benefit is the sum of both persons' benefit amounts. In step 372, an investment rate or growth rate is applied to the investment account balance to determine the value of the variable futureValue. In step 374, total annual social security benefits are added to investment account balance (futureValue) and the values are stored in an array. In step 376, it is determined whether this is the last year to illustrate. If the year for the current iteration is not the last year to illustrate, control proceeds to step 378 where the participants' ages are incremented, and control returns to step 370 for the next iteration. If the current year is the last year to illustrate, control proceeds to step 380 where the process ends and the array of annual calculation values is returned.

FIG. 10 is a flow chart illustrating exemplary steps for calculating a social security benefit amount according to an embodiment of the subject matter described herein. Referring to FIG. 10, in step 382, that age for the person for whom benefits are being calculated in the year illustrated is determined. In step 384, the person's age is compared to the start age for social security benefits. If the current age is less than the start age, the process ends and returns zero. If the current age greater than or equal to the start age, control proceeds to step 386 where the Full Retirement Age amount times cost of living adjustment is determined. In step 388, the current age is compared to the full retirement age. If the current age is equal to the full retirement age, control proceeds to step 392 where the process ends and the benefit amount is returned. If the current age is not equal to the Full Retirement age, control proceeds to step 390 where a reduction formula is applied if less than Full Retirement Age or a delay benefits formula is applied if the current age is greater than full retirement age. Control then proceeds to step 392 where the benefit amount is returned.

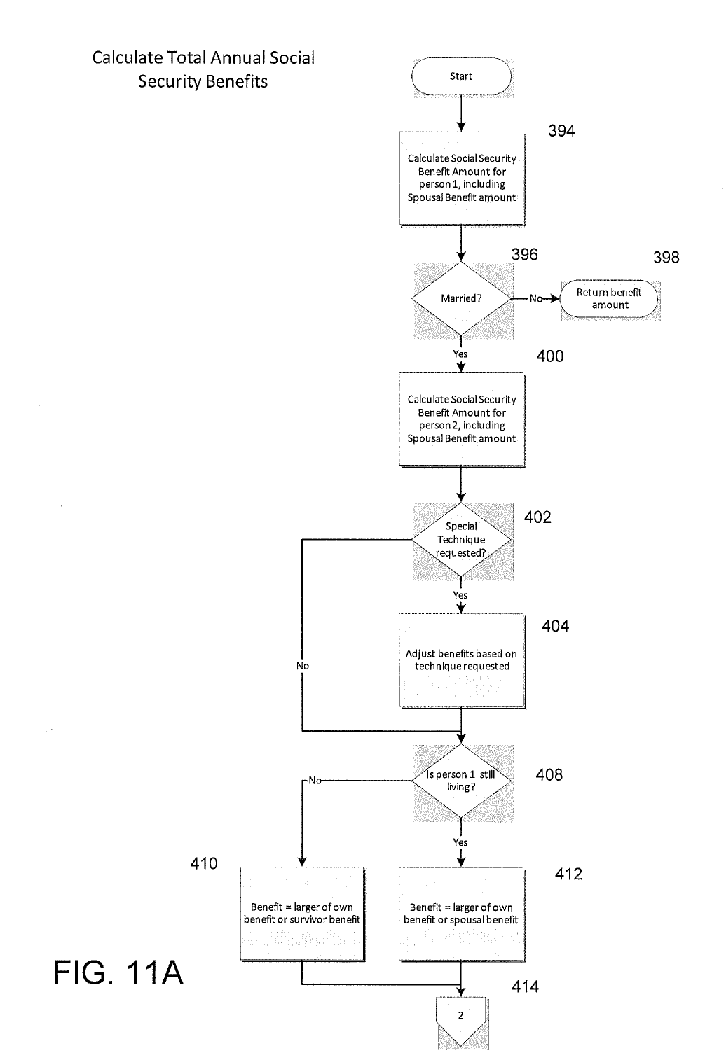

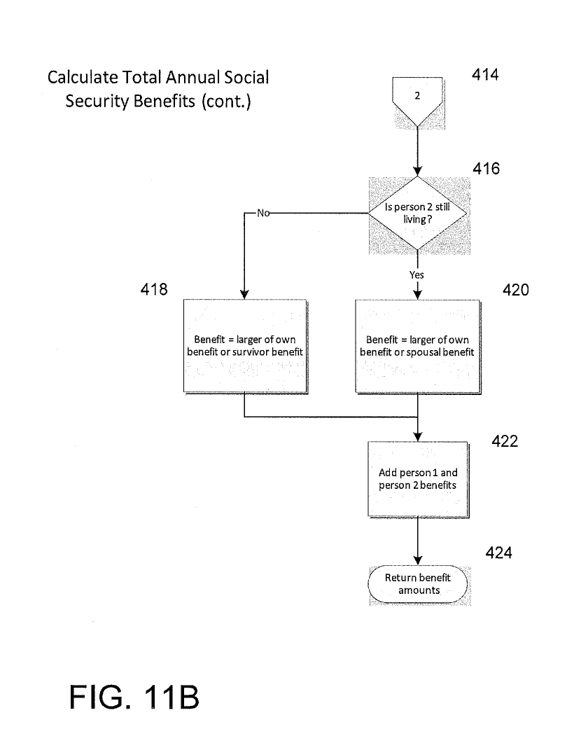

FIGS. 11A and 11B are flow charts illustrating exemplary steps for calculating annual social security benefits according to an embodiment of the subject matter described herein. Referring to FIG. 11A, in step 394, the Social Security benefit for person 1 is calculated as described in FIG. 10. In step 396, it is determined whether person 1 is or has been married. If person 1 is not and has not been married, control proceeds to step 398 where the social security benefit amount for person 1 is returned. If person 1 is or has been married, control proceeds to step 400 where the benefit amount for person 2 is calculated as described in FIG. 10.

In step 402, it is determined whether a special filing strategy is requested. If a special strategy is not requested, control proceeds to step 408. If a special strategy is requested, control proceeds to step 404 where benefits are adjusted based on the strategy requested. Examples of special strategies include file and suspend and restricted application. If the selected strategy is file and suspend, and the age of the person is greater than the full retirement age. If file and suspend is selected and the person's age is greater than full retirement age, the benefit is set to 0 until the start age. If the strategy is restricted application, the benefit is set to 0 until age 70 then starts with delay increases. The selected strategy is applied to each person as indicated. If the selected filing options are a combination of file and suspend and restricted application, then the combination may be applied to both persons' benefits.

In step 408, it is determined whether person 1's age is less than the death age. If person 1's age is greater than or equal to the death age, then control proceeds to step 410, where the benefit is determined to be the larger of person 2's own benefit and the survivor's benefit. If in step 408 it is determined that the persons age is less than the death age, control proceeds to step 412, where the person's benefit is determined to be the larger of person 1's own benefit and the spousal benefit.

Referring to FIG. 11B, in step 414, the benefit calculation process continues. In step 416, it is determined whether person 2's age less than death age? If person 2's age is greater than or equal to the death age, control proceeds to step 418, where the benefit is set to the larger of person 1's own benefit or survivor's benefit. If person 2's age is less than the death age, control proceeds to step 420 where the benefit is set to the larger of person 2's own benefit or the spousal benefit. In step 422, the benefits determined for person 1 and person 2 are added to get the total annual benefit. In step 424, the total annual benefit is returned.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for determining and presenting optimum social security benefits filing strategies, the method comprising:
using a programmed computer:
receiving input regarding at least one social security retirement benefits participant's age;
receiving input regarding the at least one social security retirement benefits participant's full retirement age benefit amount;
calculating, for each plurality of filing strategies and based on the inputs and a life expectancy of the at least one social security retirement benefits participant, a monetary value of social security benefits for a plurality of different benefits start ages of the at least one social security retirement benefits participant; and
outputting an indication of relative monetary benefits for the different benefits start ages.

2. The method of claim 1 wherein receiving input regarding at least one social security retirement benefits participant's age includes receiving input regarding a participant's age and a participant's spouse's age and wherein outputting an indication of the relative monetary benefits for different benefits start ages comprises outputting a matrix indicating a value of social security benefits for a plurality of combinations of the participant's benefits start age and the participant's spouse's benefits start age.

3. The method of claim 2 wherein the matrix comprises a two-dimensional matrix where each cell in the matrix indicates a value of social security benefits for a combination of the participant's benefits start age and the participant's spouse's benefits start age.

4. The method of claim 2 wherein outputting an indication of the relative monetary benefits of the different filing strategies includes displaying a benefits start age combination for the participant and the participant's spouse that yields the highest monetary benefit relative to other combinations of start ages.

5. A system for determining and presenting an optimum social security benefits strategy, the system comprising:
an input module for receiving input regarding at least one social security retirement benefits participant's age and full retirement age benefit amount;
a social security benefits calculator for calculating, for each of a plurality of filing strategies and based on the input and a life expectancy of the at least one social security benefits participant, a monetary value of social security benefits for a plurality of different benefits start ages of the at least one social security retirement benefits participant; and
an output module for outputting an indication of the relative monetary benefits for the different benefits start ages.

6. The system of claim 5 wherein receiving input regarding at least one social security retirement benefits participant's age includes receiving input regarding a participant's age and a participant's spouse's age and wherein the output module is configured to output a matrix indicating a value of social security benefits for a plurality of combinations of the participant's benefits start age and the participant's spouse's benefits start age.

7. The system of claim 6 wherein the matrix comprises a two-dimensional matrix where each cell in the matrix indicates a value of social security benefits for a combination of the participant's benefits start age and the participant's spouse's benefits start age.

8. The system of claim 6 wherein the output module is configured to display a benefits start age combination for the participant and the participant's spouse that yields the highest monetary benefit relative to other combinations of start ages.

9. A non-transitory computer readable medium having stored thereon executable instructions that when executed by the processor of a computer control the computer to perform steps comprising:
using a programmed computer;
receiving input regarding at least one social security retirement benefits participant's age;
receiving input regarding the at least one social security retirement benefits participant's benefit amount;
calculating, for each plurality of filing strategies and based on the inputs and a life expectancy of the at least one social security retirement benefits participant, a monetary value of social security benefits for a plurality of different benefits start ages if the at least one social security retirement benefits participant; and
outputting an indication of relative monetary benefits for the different benefits start ages.
